(19) United States
(12) Patent Application Publication
(10) Pub. No.: US 2025/0200795 A1
(43) Pub. Date: Jun. 19, 2025

(54) POSITION ESTIMATION DEVICE, VEHICLE, VEHICLE POSITION ESTIMATION METHOD, AND NON-TRANSITORY COMPUTER READABLE STORAGE MEDIUM

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Naoki OOARATA, Nisshin-shi (JP)

(21) Appl. No.: 18/823,803

(22) Filed: Sep. 4, 2024

(30) Foreign Application Priority Data
Dec. 14, 2023 (JP) 2023-210903

(51) Int. Cl. G06T 7/73; B60Q 1/24; G06V 10/60; G06V 20/58

(52) U.S. Cl. CPC G06T 7/74; B60Q 1/249; G06V 10/60; G06V 20/584; G06T 2207/10048; G06T 2207/30264

(57) ABSTRACT

A position estimation device estimates a position of a vehicle during a reverse operation. The position estimation device includes a reverse operation detection unit, an illumination instruction unit, an image obtaining unit, and position estimation unit. The reverse operation detection unit detects the reverse operation of the vehicle. The illumination instruction unit instructs a light source device to illuminate a rear area of the vehicle with near-infrared light when the reverse operation is detected. The image obtaining unit obtains an image of the rear area of the vehicle, and the image is captured by an imaging device of the vehicle while the rear area is being illuminated with the near-infrared light. The position estimation unit detects a feature point of the image using a feature point extraction device or algorithm based on luminance information of the image, and estimates the vehicle position using the detected feature point.

### CROSS REFERENCE TO RELATED APPLICATION

The present application claims the benefit of priority from Japanese Patent Application No. 2023-210903 filed on Dec. 14, 2023. The entire disclosure of the above application is incorporated herein by reference.

### TECHNICAL FIELD

The present disclosure relates to a position estimation device, a vehicle, a vehicle position estimation method, and a non-transitory computer readable storage medium storing a computer program.

### BACKGROUND

There is a technique for assisting parking when a vehicle reverses by estimating a vehicle position using an image captured by a camera mounted on the vehicle.

### SUMMARY

A position estimation device is provided. The position estimation device is configured to estimate, as a vehicle position, a position of a vehicle during a reverse operation, the position estimation device includes a reverse operation detection unit, an illumination instruction unit, an image obtaining unit, and a position estimation unit. The reverse operation detection unit is configured to detect the reverse operation of the vehicle. The illumination instruction unit is configured to instruct a light source device having a near-infrared light source to illuminate a rear area of the vehicle with near-infrared light when the reverse operation is detected. The image obtaining unit is configured to obtain an image of the rear area of the vehicle. The image is captured by an imaging device of the vehicle while the rear area is being illuminated with the near-infrared light. The position estimation unit is configured to detect a feature point of the image using a feature point extraction device or algorithm based on luminance information of the image, and estimate the vehicle position using the detected feature point.

### BRIEF DESCRIPTION OF THE DRAWINGS

FIG. 1 is a block diagram showing a schematic configuration of a vehicle including a vehicle position estimation device according to a first embodiment of the present disclosure.

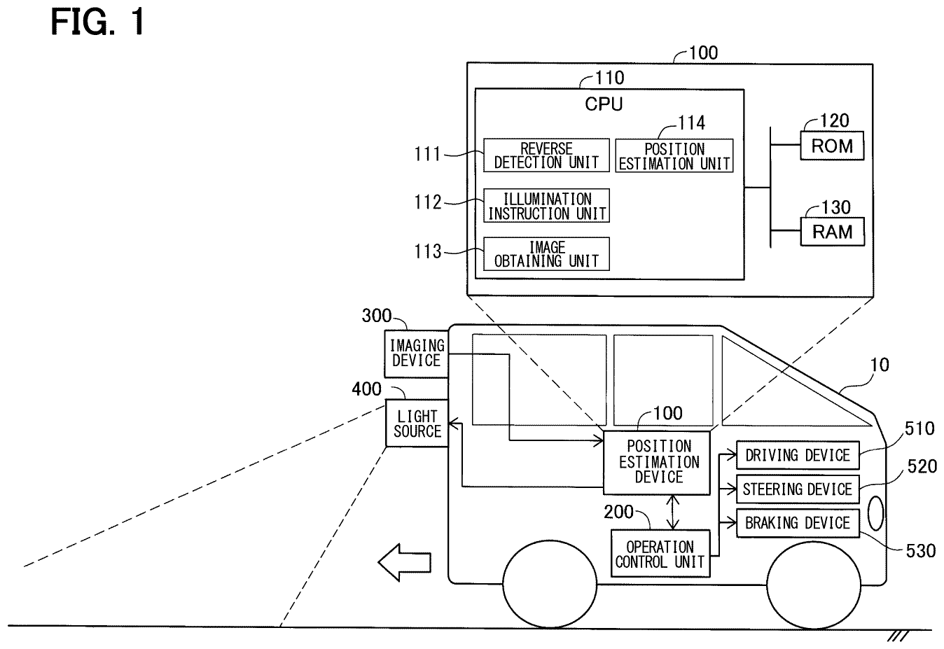

FIG. 2 is an explanatory diagram for explaining a feature point detection method in FAST.

FIG. 3 is a flowchart showing a procedure of vehicle position estimation processing in the first embodiment.

FIG. 4 is a flowchart showing a detail procedure of the vehicle position estimation.

FIG. 5 is a block diagram showing a schematic configuration of a vehicle including a position estimation device according to a second embodiment.

### DETAILED DESCRIPTION OF THE PREFERRED EMBODIMENTS

To begin with, relevant examples of the present disclosure will be explained.

As a technique for assisting parking when a vehicle reverses, various techniques have been proposed that estimate the vehicle position by using an image captured by a camera mounted in the vehicle. As one such technique, there is a method for estimating the vehicle position with feature points of captured images. The method includes detecting feature points of the captured images using a feature point extraction algorithm based on luminance, such as Features from Accelerated Segment Test (FAST), estimating changes in the vehicle position from changes in the feature points over time, and estimating the vehicle position using the estimated changes in the vehicle position.

However, in a low-illumination environment where the illuminance of the ambient light is low, such as at night, the difference between the ambient light and the noise is small, making it difficult to detect feature points with high accuracy. As a result, the accuracy of estimating the vehicle position decreases. Thus, a technology is needed that can accurately detect feature points from captured images for parking assistance during vehicle reversing in a low-illumination environment.

According to one aspect of the present disclosure, a position estimation device is provided. The position estimation device is configured to estimate, as a vehicle position, a position of a vehicle during a reverse operation, the position estimation device includes a reverse operation detection unit, an illumination instruction unit, an image obtaining unit, and a position estimation unit. The reverse operation detection unit is configured to detect the reverse operation of the vehicle. The illumination instruction unit is configured to instruct a light source device having a near-infrared light source to illuminate a rear area of the vehicle with near-infrared light when the reverse operation is detected. The image obtaining unit is configured to obtain an image of the rear area of the vehicle. The image is captured by an imaging device of the vehicle while the rear area is being illuminated with the near-infrared light.

The position estimation unit is configured to detect a feature point of the image using a feature point extraction device or algorithm based on luminance information of the image, and estimate the vehicle position using the detected feature point.

According to the position estimation device of the above embodiment, the rear area of the vehicle is illuminated with near-infrared light when a reverse operation is detected, and feature points are detected based on images that are captured while the rear area of the vehicle is being illuminated with the near-infrared light. Thus, the position estimation device can increase the luminance of the rear area of the vehicle with near-infrared light even in a low-illumination environment where the illuminance of the ambient light is low. Therefore, the difference between the ambient light and the noise can be increased, and feature points can be detected with high accuracy from the captured image for parking assistance during reverse operation in a low-illumination environment.

The present disclosure can be realized in various forms, such as a vehicle, a vehicle position estimation method, a computer program for implementing the position estimation device and the position estimation method, a non-transitory storage medium storing the computer program.

A. First embodiment: A1. Device configuration: A position estimation device 100 shown in FIG. 100 is installed and used in a vehicle 10. The configuration of the vehicle 10 will be described. The vehicle 10 is a mobile object that runs on wheels, and may be any type of mobile object, such as a vehicle equipped with a gasoline engine, an electric vehicle (BEV: Battery Electric Vehicle), a hybrid vehicle, or a fuel cell vehicle. The vehicle 10 has two driving modes: manual driving and autonomous driving. Manual driving is a driving mode in which the driver of the vehicle 10 drives the vehicle 10 by operating parts of the vehicle 10 such as the steering wheel, accelerator pedal, and brake pedal. Autonomous driving is a driving mode in which at least one of acceleration/deceleration, steering, and braking of the vehicle 10 is controlled autonomously without relying on instructions from the driver. In this embodiment, autonomous driving is executed when the vehicle 10 reverses for parking (hereinafter referred to as a “reverse parking operation”). In this embodiment, manual driving and autonomous driving are switched when the driver performs a predetermined operation, such as pressing a physical operation button (not shown) or pressing an operation button on a menu screen displayed on an operation display (not shown).

In addition to the position estimation device 100, which will be described in detail later, the vehicle 10 includes an operation control unit 200, an imaging device 300, a light source device 400, a driving device 510, a steering device 520, and a braking device 530.

The operation control unit 200 controls operations of the vehicle 10. Specifically, the operation control unit 200 controls operations of actuators that change the acceleration/deceleration and steering angle of the vehicle 10, thereby controlling operations of the vehicle 10, such as “running”, “turning”, and “stopping” of the vehicle 10. In this embodiment, the above-mentioned actuators include an actuator of the driving device 510, an actuator of the steering device 520, and an actuator of the braking device 530. The operation control unit 200 can exchange data with the position estimation device 100, the driving device 510, the steering device 520, and the braking device 530 via a network such as a Control Area Network (CAN). In this embodiment, the operation control unit 200 is configured as an Electronic Control Unit (ECU) including a CPU and a memory.

The driving device 510 is a device for driving the vehicle 10, and corresponds to components such as a motor and an inverter device that controls rotation of the motor. The steering device 520 is a device for changing the traveling direction of the vehicle 10, and corresponds to components such as a power steering motor and a hydraulic device. The braking device 530 is a device for applying brakes to the vehicle 10, and corresponds to components such as a hydraulic device and a valve.

The imaging device 300 captures an image of an area behind the vehicle 10 and obtains a captured image. The imaging device 300 has a light-receiving element capable of receiving reflected light of near-infrared light that is emitted from the light source device 400, and captures an image of a subject reflected by the reflected light. “Near-infrared light” refers to electromagnetic waves having wavelengths between 780 nanometers nm and 2500 nm, for example. In this embodiment, the imaging device 300 is attached to an upper portion of the exterior surface of the body of the vehicle 10 that faces rearward. Therefore, obstacles are few and the influence of the lighting environment of the vehicle cabin is less compared to a configuration in which the imaging device 300 is mounted in the vehicle cabin of the vehicle 10, so that a more suitable image can be obtained for detecting feature points. The angle of view of the imaging device 300 and the orientation of the imaging device 300 are preset to an angle of view and orientation such that the imaging range includes a reverse direction portion of the road on which the vehicle 10 is scheduled to move when reversing, right and left portions shifted from the reverse direction portion to the left and right respectively by a distance of at least the width of one vehicle, and areas extending vertically upward from the reverse direction portion and the right and left portions to a position at least the height of the vehicle 10. The imaging device 300 is electrically connected to the position estimation device 100 and is configured to transmit image data of the captured image to the position estimation device 100.

The light source device 400 has a light source that can emit near-infrared light, and is configured to illuminate the rear area that is behind the vehicle 10. In this embodiment, the light source device 400 is attached to an upper portion of the external surface of the body of the vehicle 10 facing rearward, similar to the imaging device 300. Therefore, compared to a configuration in which the light source device 400 is mounted inside the vehicle 10, obstacles are few, and the rear area of the vehicle 10 is appropriately illuminated with near-infrared light. The illumination range of the light source device 400 is a part of the imaging range of the imaging device 300 near the vehicle 10. Specifically, the illumination range of the light source device 400 is a part of the reverse direction portion of the road on which the vehicle is scheduled to drive when reversing, which is from a current position of the vehicle 10 (hereinafter referred to as a vehicle position) to a position rearward along a length direction of the vehicle by a predetermined distance. The light source device 400 emits near-infrared light to the rear area of the vehicle 10, and the imaging device 300 captures an image of the subject reflected by the near-infrared light, so that the subject (i.e., features) present behind the vehicle 10 can be captured even in a low-illumination environment such as at night. The light source device 400 is electrically connected to the position estimation device 100, and the position estimation device 100 controls the on/off of the illumination with near-infrared light.

The position estimation device 100 estimates the vehicle position. In this embodiment, the position estimation device 100 is configured as an ECU including a CPU 110, a ROM 120, and a RAM 130. The CPU 110 loads a control program pre-stored in the ROM 120 onto the RAM 130 and executes the control program to function as a reverse operation detection unit 111, an illumination instruction unit 112, an image obtaining unit 113, and a position estimation unit 114.

The reverse operation detection unit 111 detects a reverse operation of the vehicle 10. This detection may be performed by obtaining a detection result that the shift range is “R” (reverse) from a sensor that detects the shift range mounted in the vehicle 10. Alternatively, the detection may be performed using detection results of a sensor that detects the rotation direction of the wheels or the rotation direction of the vehicle axis.

The illumination instruction unit 112 instructs the light source device 400 to turn on and off the illumination with near-infrared light. The instruction to “turn on the illumination with near-infrared light” corresponds to an instruction to illuminate the rear area of the vehicle 10 with near-infrared light. The image obtaining unit 113 is configured to obtain an image that is captured by the imaging device 300. That is, the image obtaining unit 113 obtains an image of the rear area of the vehicle 10 that is captured by the imaging device 300.

The position estimation unit 114 is configured to detect feature points of the obtained image with a feature point extraction device or algorithm based on luminance information and estimate the vehicle position with the detected feature points. The term “a feature point extraction device or algorithm based on luminance information” refers to an algorithm configured to obtain difference information by comparing luminance of the image, which is captured by the imaging device 300, with a predetermined threshold luminance for each pixel and detect feature points from the difference information, or a device configured to execute the algorithm. The image captures an area in a reversing direction of the vehicle and a vicinity of the vehicle. In this embodiment, Features from Accelerated Segment Test (FAST) or a device that executes FAST is used as such a device or algorithm. In FAST, corner points are detected as feature points. Then, the position estimation unit 114 identifies positional change of the same corner point at different times, and identifies changes in the vehicle position using the positional change of the corner point. When the position of a parking space is predetermined as the vehicle position at the start of driving, the current vehicle position can be identified by using the change in the vehicle position based on the parking space as a reference.

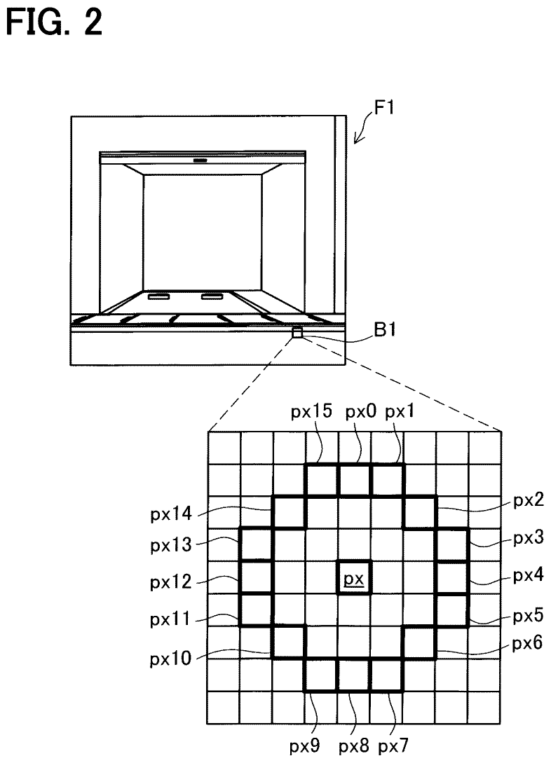

A method of detecting feature points (i.e., corner points) using FAST will be described with reference to FIG. 2. In FIG. 2, an image F1 is shown in the upper left portion as an example of the captured image. Also, a pixel block B1 in the image F1 is shown in an enlarged scale at the bottom right portion of FIG. 2.

In FAST, the central pixel in the pixel block B1 of 9 pixel×9 pixel is firstly set as an interest pixel px, and 16 pixels surrounding the interest pixel px are set as surrounding pixels px0 to px15. Next, it is determined whether each of the surrounding pixels px0 to px15 corresponds to a Brighter pixel or a Darker pixel as described below. In this case, the surrounding pixels are sequentially set as target pixels from the pixel px0 to the pixel px15 clockwise around the interest pixel px such that the pixel px0 is set as the first target pixel, the pixel px1 is set as the second target pixel, the pixel px2 is set as the third target pixel. In the following description, luminance Bn (n is 0 to 15) refers to the luminance value of each of the surrounding pixels px0 to px15. L refers to the luminance value of the interest pixel px. Also, Bth refers to a luminance threshold value. (i) Brighter pixel is a pixel that satisfies L+Bth<Bn, and (ii) Darker pixel is a pixel that satisfies L−Bth>Bn.

As described above, it is determined whether each of the surrounding pixels px0 to px15 is a brighter pixel or a darker pixel. If a predetermined number of the surrounding pixels are identified as brighter pixels in succession, or if a predetermined number of the surrounding pixels are identified as darker pixels in succession, it is determined that the interest pixel px is a feature point (i.e., a corner point). The above-mentioned “the predetermined number of the surrounding pixels” is nine. The predetermined number is not limited to nine, but may be set to another number such as ten. In a low-illumination environment, the S/N ratio of luminance value of each pixel in the captured image (i.e., the ratio of reflected light of near-infrared light and noise light due to other environment light) is low. When corner points are detected using FAST in the low-illumination environment, the luminance value of the position corresponding to each pixel may not be obtained correctly. In such a situation, it is not possible to accurately determine whether each pixel is a brighter pixel or a darker pixel, and as a result, it may not be possible to accurately determine feature points (i.e., corner points), and furthermore, it may not be possible to accurately determine the vehicle position. Therefore, the position estimation device 100 of this embodiment executes the vehicle position estimation process described below to detect accurately feature points (i.e., corner points) from the captured image to provide parking assistance when reversing in a low-illumination environment.

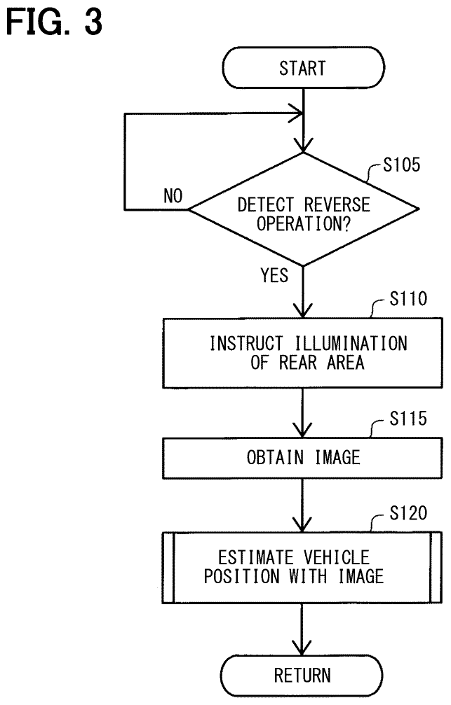

A2. Vehicle position estimation processing: The vehicle position estimation processing shown in FIG. 3 is a process for estimating the vehicle position, and is executed as a part of the parking assistance processing. The “parking assistance processing” is processing for autonomously parking the vehicle 10 in a parking space. Pressing an operation button (not shown) of the vehicle 10 by the driver or the like starts the execution of the vehicle position estimation processing as a part of the parking assistance processing. At the same time, the operation control unit 200 executes driving operation assistance processing. The “driving operation assistance processing” includes processing of determining a route to a planned parking position based on an estimated vehicle position, processing of setting target positions every specified distance (e.g., every 0.5 m) for driving along the determined route, processing of determining the amount of acceleration, steering, and braking for driving from the current position to the initial target position, and processing of creating commands to realize the determined amount of acceleration, steering, and braking and outputting the commands to the driving device 510, the steering device 520, and the braking device 530. The parking assistance processing is executed, for example, when the driver of the vehicle 10 stops the vehicle near a parking lot and presses an operation button in the vehicle stopped state to execute the parking assistance processing.

The reverse operation detection unit 111 determines whether a reverse operation of the vehicle 10a has been detected (step S105). When it is determined that the reverse operation is not detected (step S105: NO), step S105 is executed again. On the other hand, if it is determined that the reverse operation has been detected (step S105: YES), the illumination instruction unit 112 orders illumination with near-infrared light. That is, the illumination instruction unit 112 orders illumination on the rear area of the vehicle 10 with near-infrared light. A period in which the rear area is illuminated at this time is set to a period in which the imaging device 300 can capture an image while the rear area is being illuminated with near-infrared light. The image obtaining unit 113 obtains a captured image of the rear area of the vehicle 10 that is captured by the imaging device 300 while the rear area is being illuminated with near-infrared light (step S115). The position estimation unit 114 estimates the vehicle position using the image obtained in step S115 (step S120). After completing step S120, the processing returns to step S105.

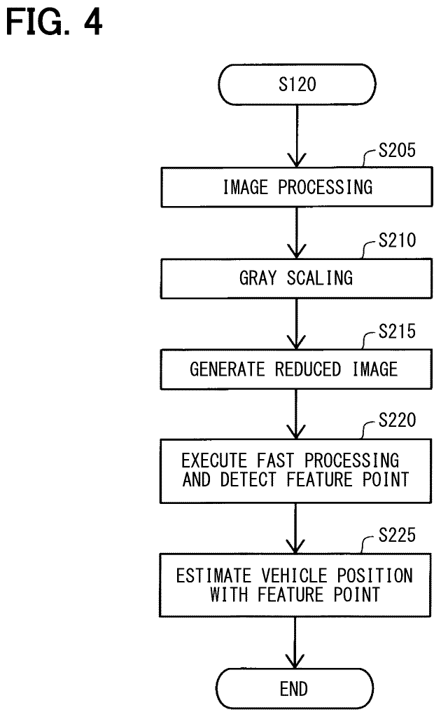

FIG. 4 shows the detailed procedure of step S120 in FIG. 3. The position estimation unit 114 executes a predetermined type of image processing on the image obtained in step S115 (step S205). The predetermined type of image processing includes, for example, demosaicing processing, noise removal processing, and distortion correction processing. Next, the position estimation unit 114 executes grayscale processing on the processed image (step S210). In step S210, for example, 8-bit grayscaling is performed. Note that the grayscaling is not limited to 8 bits and may be performed using any number of bits. The position estimation unit 114 creates a reduced image by multi stages from the grayscaled image (step S215). In step S215, for example, a reduced image by 8 stages is created. The position estimation unit 114 executes the FAST processing to detect feature points (i.e., corner points) (step S220). In the above explanation using FIG. 2, the interest pixel px in the pixel block B1 is identified as the feature point. In step S220, the interest pixel px is sequentially changed within the captured image (e.g., the image F1) while detecting feature points. That is, the position estimation unit 114 performs processing of identifying each of pixels as the brighter pixel or darker pixel as changing the interest pixel px and processing of determining whether the predetermined number of pixels are identified as brighter pixels in succession or as darker pixels in succession. The above processing is performed on all pixel blocks within the image F1, not limited to the pixel block B1. The position estimation unit 114 estimates the vehicle position using the feature points detected in step S220 (step S225).

When the vehicle 10 is parked in the parking space as a result of repeatedly executing the vehicle position estimation processing and driving operation assistance processing described above, the vehicle position estimation processing and driving operation assistance processing (i.e., the parking assistance processing) end.

According to the position estimation device 100 of the first embodiment described above, the rear area of the vehicle 10 is illuminated with near-infrared light when a reverse operation is detected, and the feature points are extracted based on the image that is captured while the rear area is being illuminated with near-infrared light. That is, near-infrared light increases the illuminance of the rear area of the vehicle 10 even in a low-environmental light situation. Therefore, the difference between the ambient light and the noise can be increased, and feature points can be detected with high accuracy from the captured image for parking assistance during reverse operation in a low-illumination environment.

In addition, the feature point extraction device or algorithm obtains difference information by comparing the predetermined threshold luminance with the luminance of each pixel in the image captured by the imaging device 300, which captures an area of the vehicle 10 in a reversing direction and the vicinity of the vehicle 10. The feature point extraction device or algorithm detects the feature points from the difference information, thereby detecting the feature points accurately.

Furthermore, since the imaging device 300 is attached to the external surface of the body of the vehicle 10, a more suitable image can be obtained for detecting feature points compared to a configuration in which the imaging device 300 is attached inside the vehicle 10. In addition, since the light source device 400 is also attached to the external surface of the body of the vehicle 10, the light source device 400 can appropriately illuminate the rear area of the vehicle 10 with near-infrared light.

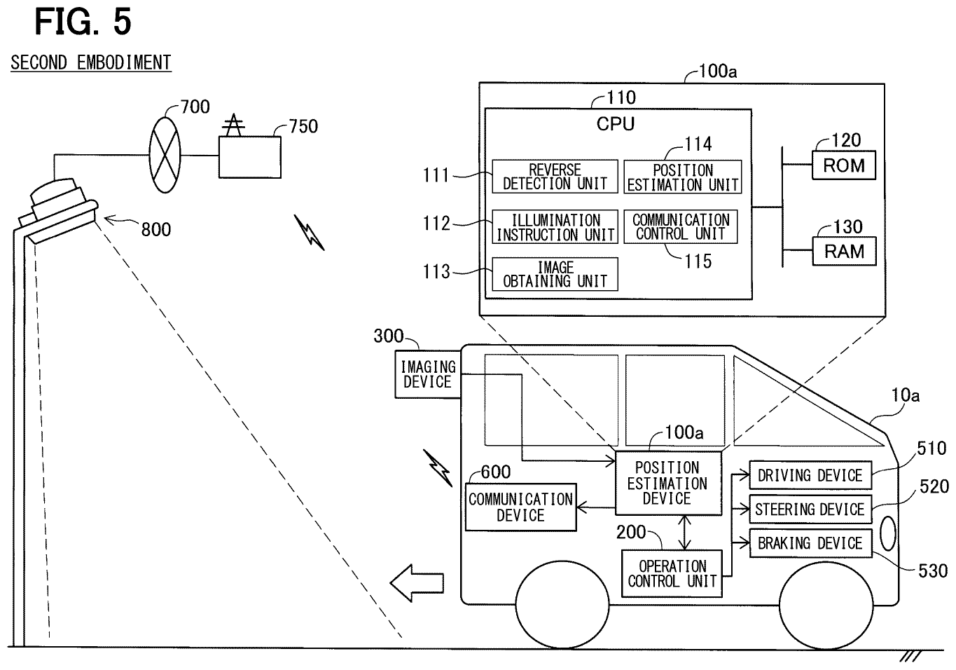

B. Second embodiment: A vehicle 10a according to a second embodiment shown in FIG. 5 differs from the vehicle 10 according to the first embodiment in that the vehicle 10a does not include the light source device 400 and additionally includes a communication device 600 and a position estimation device 100a instead of the position estimation device 100. The other configurations of the vehicle 10a of the second embodiment are the same as those of the vehicle 10 of the first embodiment, so the same reference numerals are used and detailed description thereof is omitted.

The position estimation device 100a of the second embodiment differs from the position estimation device 100 of the first embodiment in that the CPU 110 also functions as a communication control unit 115. Since the other configurations of the position estimation device 100a of the second embodiment are the same as those of the position estimation device 100 of the first embodiment, the same components are designated by the same reference numerals, and detailed description thereof will be omitted.

The communication device 600 performs wireless communication. Examples of wireless communication include wireless communication using wireless communication services provided by wireless communication carriers, such as 4G (fourth generation) communication and 5G (fifth generation) communication, and wireless LANs. The communication device 600 is electrically connected to the position estimation device 100a, and outputs communication data as a wireless signal in response to instructions from the position estimation device 100a. Further, the communication device 600 also receives the wireless signal and outputs communication data obtained from the wireless signal to the position estimation device 100a.

The communication control unit 115 communicates with a light source device 800, which will be described later, via the communication device 600. The communication control unit 115 is a functional unit that is realized by the CPU 110 loading a control program that is pre-stored in the ROM 120 onto the RAM 130 and executing the control program, similar to the other functional units 111 to 114.

The light source device 800 is a separate object from the vehicle 10a, and is installed on the ground around the area where the vehicle 10a reverses, such as the parking space. The light source device 800 is configured to emit near-infrared light toward the parking space, similar to the light source device 400 of the first embodiment. The light source device 800 includes a control device and a communication device, both of which are not shown. The control device included in the light source device 800 controls the on/off of the illumination with near-infrared light. Further, the communication device included in the light source device 800 communicates with the vehicle 10a via the network 700. The network 700 includes a wireless base station 750 in the vicinity of the parking space, and wireless signals are exchanged between the communication device 600 of the vehicle 10a and the wireless base station 750.

The vehicle 10a of the second embodiment having the above-mentioned configuration also executes the vehicle position estimation processing of the first embodiment shown in FIG. 3. However, in step S110, the illumination instruction unit 112 uses communication between the communication control unit 115 and the light source device 800 to order illumination of the parking space, which is the rear area of the vehicle, with near-infrared light.

The position estimation device 100a of the second embodiment described above has similar effects as those of the position estimation device 100 of the first embodiment. In addition, the position estimation device 100a further includes the communication control unit 115 for communicating with the light source device 800 via the communication device 600 of the vehicle 10a. The communication control unit 115 uses the communication between the communication control unit 115 and the light source device 800 for instructing the light source device 800 to emit near-infrared light on the rear area of the vehicle 10a when a reverse operation is detected. Thus, even when the vehicle is not equipped with the light source device, the rear area of the vehicle 10a can be illuminated with near-infrared light during reverse operation.

C. Other Embodiments: (C1) In each embodiment, the “feature point extraction device or algorithm based on luminance information” is FAST or a device that executes FAST, but the present disclosure is not limited to this. The feature point extraction device or algorithm based on luminance may be, for example, an Oriented FAST and Rotated Test (ORB), which obtains difference information by comparing luminance of each pixel of the image captured by the imaging device 300, which captures an area in the reversing direction of the vehicle 10 and the vicinity of the vehicle 10, with the predetermined threshold luminance, and detects a feature point from the difference information.

(C2) In the first embodiment, the imaging device 300 and the light source device 400 are attached to the external surface of the body of the vehicle 10. In the second embodiment, the imaging device 300 is attached to the external surface of the body of the vehicle 10. However, the present disclosure is not limited thereto. For example, at least one of the imaging device 300 and the light source device 400 may be provided inside the vehicle 10, 10a. Such configuration can simplify waterproofing measures and measures to protect against high temperatures caused by direct sunlight, for at least one of the imaging device 300 and the light source device 400 in the vehicle cabin. Furthermore, installing the device in the vehicle cabin means that the temperature change and vibrations are reduced in the environment of the device compared to the configuration where the device is attached to the external surface of the body. Thus, installing the device in the vehicle cabin further simplify measures against the temperature change and vibrations. These measures reduce the manufacturing costs of the vehicles 10, 10a.

(C3) In each embodiment, the vehicles 10, 10a include the imaging device 300 that captures an image of a subject reflected by near-infrared light. However, in addition to the imaging device 300, the vehicles 10, 10a may include an imaging device (e.g., camera) that captures an image of a subject reflected by visible light, and feature points may be detected using an image (hereinafter referred to as a “visible light image”) obtained by the imaging device also. Specifically, feature points are detected from a captured image (hereinafter referred to as a “near-infrared light image”) obtained by the imaging device 300, and feature points are also detected separately from a visible light image. Then, when a feature point detected based on the near-infrared light image matches a feature point detected from the visible light image, the matched feature point may be used to estimate the vehicle position. This configuration can avoid using erroneously detected feature points for vehicle position estimation, thereby enabling vehicle position estimation with higher accuracy. In the above configuration, feature points may be detected from two types of captured images during the day, and feature points may be extracted only from the near-infrared light image at night, similar to the other embodiments. In this way, issues that feature points cannot accurately detected at night can be solved.

(C4) In each embodiment, the “parking assistance processing” includes vehicle position estimation processing and driving operation assistance processing. However, the parking assistance processing may include any type of assistance processing that uses the estimated vehicle position instead of the driving operation assistance processing. For example, during parking operation, the driving mode of the vehicle 10, 10a is a manual driving mode, and the parking assistance processing may include processing to detect whether the vehicle 10, 10a is about to hit an object around the vehicle 10, 10a (e.g., a curb and a utility pole) based on the vehicle position estimated by the vehicle position estimation processing, and to warn the driver with an alarm sound when determining that the vehicle 10, 10a is about to hit an object.

(C5) The position estimation device 100, 100a in this disclosure and the technique thereof may be achieved by a dedicated computer provided by constituting a processor and a memory programmed to execute one or more functions embodied by a computer program. Alternatively, the position estimation device 100, 100a in this disclosure and the techniques thereof may be implemented by a dedicated computer provided by configuring the processor with one or more dedicated hardware logic circuits. Alternatively, the position estimation device 100, 100a in this disclosure and methods thereof described in the present disclosure may be implemented by one or more dedicated computers configured with a combination of a processor and a memory programmed to execute one or more functions, and a processor configured with one or more hardware logic circuits. The computer program may be stored in a computer-readable non-transitory tangible storage medium as an instruction executed by a computer.

The present disclosure is not limited to the embodiments described above, and various other embodiments may be implemented without departing from the scope of the present disclosure. For example, the technical features in each embodiment may be used to solve some or all of the above-described problems, or to provide one of the above-described effects. In order to achieve a part or all, replacement or combination can be appropriately performed. Also, if the technical features are not described as essential in the present specification, they may be omitted as appropriate.

1. A position estimation device configured to estimate, as a vehicle position, a position of a vehicle during a reverse operation, the position estimation device comprising:
a reverse operation detection unit configured to detect the reverse operation of the vehicle;
an illumination instruction unit configured to instruct a light source device having a near-infrared light source to illuminate a rear area of the vehicle with near-infrared light when the reverse operation is detected;
an image obtaining unit configured to obtain an image of the rear area of the vehicle, the image being captured by an imaging device of the vehicle while the rear area is being illuminated with the near-infrared light; and
a position estimation unit configured to:
detect a feature point of the image using a feature point extraction device or algorithm based on luminance information of the image; and
estimate the vehicle position using the detected feature point.

2. The position estimation device according to claim 1, wherein
the feature point extraction device or algorithm is configured to:
obtain difference information by comparing a luminance of the image of the rear area captured by the imaging device with a predetermined threshold luminance for each pixel; and
detect the feature point from the difference information.

3. The position estimation device according to claim 1, wherein
the light source device is disposed at a position near an area where the vehicle performs the reverse operation,
the position estimation device further comprising
a communication control unit configured to communicate with the light source device through a communication device in the vehicle, wherein
the illumination instruction unit is configured to instruct the light source device to illuminate the rear area of the vehicle with the near-infrared light through a communication between the communication control unit and the light source device when the reverse operation is detected.

4. A vehicle comprising:
the position estimation device according to claim 1; and
an operation control unit configured to control a parking operation including the reverse operation of the vehicle using the vehicle position estimated by the position estimation device.

5. A position estimation method to estimate, as a vehicle position, a position of a vehicle during a reverse operation, the position estimation method comprising:
detecting the reverse operation of the vehicle;
instructing a light source device having a near-infrared light source to illuminate a rear area of the vehicle with near-infrared light when detecting the reverse operation;
obtaining an image of the rear area of the vehicle, the image being captured by an imaging device of the vehicle while the rear area is being illuminated with the near-infrared light;
detecting a feature point of the image using a feature point extraction device or algorithm based on luminance information of the image; and
estimating the vehicle position using the detected feature point.

6. A non-transitory computer readable storage medium storing a computer program for estimating, as a vehicle position, a position of a vehicle during a reverse operation, the computer program configured to cause a computer to execute:
detecting the reverse operation of the vehicle;
instructing a light source device having a near-infrared light source to illuminate a rear area of the vehicle with near-infrared light when detecting the reverse operation;
obtaining an image of the rear area of the vehicle, the image being captured by an imaging device of the vehicle while the rear area of the vehicle is being illuminated with the near-infrared light; and
detecting a feature point of the image using a feature point extraction device or algorithm based on luminance information; and
estimating the vehicle position with the detected feature point.
